(19) United States
(12) Patent Application Publication
(10) Pub. No.: US 2024/0187146 A1
(43) Pub. Date: Jun. 6, 2024

(54) HARQ-ACK TRANSMISSION METHOD AND APPARATUS, AND READABLE STORAGE MEDIUM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 18/285,211

(22) PCT Filed: Mar. 31, 2021
(86) PCT No.: PCT/CN2021/084489

§ 371 Date: Sep. 29, 2023

(51) Int. Cl. H04L 1/1867; H04W 72/21; H04W 72/56

(52) U.S. Cl. CPC H04L 1/1887; H04W 72/21; H04W 72/56

(57) ABSTRACT

An HARQ-ACK transmission method includes sending to a user equipment (UE) information indicating an HARQ-ACK sending mode. The HARQ-ACK sending mode includes a first sending mode or a second sending mode. The first sending mode corresponds to sending a plurality of HARQ-ACKs on different physical uplink control channels (PUCCHs), and the second sending mode corresponds to sending a plurality of HARQ-ACKs on a same PUCCH. The method further includes receiving the HARQ-ACK from the UE.

### CROSS-REFERENCE TO RELATED APPLICATION

The present application is the U.S. national phase application of International Application No. PCT/CN2021/084489, filed on Mar. 31, 2021, the disclosure of which is incorporated herein by reference in its entirety for all purposes.

### BACKGROUND

Currently, in new radio (NR), downlink data is carried on a physical downlink shared channel (PDSCH), and uplink data is carried on a physical uplink shared channel (PUSCH). A base station device schedules the PDSCH and PUSCH through the downlink control information (DCI) carried on a physical downlink control channel (PDCCH).

To ensure flexibility of the scheduling, one DCI may schedule one PDSCH or PUSCH. At a subcarrier spacing (SCS) of 960 kHz, a corresponding time slot duration is 1/64 milliseconds (ms). In a case of a large subcarrier spacing and a small time slot duration, if each PDSCH is scheduled by using a separate DCI, it will result in a high overhead of DCI blind detection.

In a multiple transmission time interval (multi-TTI) design, one DCI may schedule PDSCHs of a plurality of time slots or PUSCHs of a plurality of time slots. As illustrated by an example in a multi-TTI PDSCH scheduling scenario, one DCI may schedule four PDSCHs that are sequentially corresponding to four time slots or four PDSCH transmission occasions. These four PDSCHs may be used for transmitting different data, i.e., transmitting different transport blocks (TBs). The multi-TTI design can reduce the number of the DCI and thus reduce the complexity of DCI blind detection performed by the UE.

### SUMMARY

The present disclosure relates to the field of wireless communication technologies, and in particular to a hybrid automatic repeat request acknowledgement (HARQ-ACK) transmission method and apparatus, and a readable storage medium. In view of this, embodiments of the present disclosure provide a HARQ-ACK transmission method and apparatus, and a readable storage medium.

In a first aspect, an HARQ-ACK transmission method is provided by an embodiment of the present disclosure. The method is performed by a network device, or performed by a chip in a network device. The network device may include an access network device, such as a base station, nodeB, and the like.

The method includes sending to a UE information used for indicating an HARQ-ACK sending mode. The HARQ-ACK sending mode is a first sending mode or a second sending mode. The first sending mode corresponds to sending a plurality of HARQ-ACKs on different physical uplink control channels (PUCCHs). The second sending mode corresponds to sending a plurality of HARQ-ACKs on a same PUCCH. The method further includes receiving the HARQ-ACK from the UE.

In a second aspect, an HARQ-ACK transmission method is provided by an embodiment of the present disclosure. The method is performed by a UE, or performed by a chip in a UE. The UE may be a mobile phone.

The method includes receiving from a network device information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH. The method further includes determining the HARQ-ACK sending mode based on the information used for indicating the HARQ-ACK sending mode, and sending the HARQ-ACK to the network device by using the HARQ-ACK sending mode.

In a third aspect, an HARQ-ACK transmission apparatus is provided by the present disclosure. The apparatus includes a processor and a memory. The memory is configured to store a computer program. The processor is configured to execute the computer program to implement the first aspect or any of the possible designs of the first aspect.

It should be understood that the above general description and the later detailed description are exemplary and explanatory only and do not limit the present disclosure.

### BRIEF DESCRIPTION OF THE DRAWINGS

The accompanying drawings illustrated herein are used to provide a further understanding of the embodiments of the present disclosure and form part of the present disclosure. The schematic embodiments of the present disclosure and the illustrations thereof are used for the purpose of explaining the embodiments of the present disclosure and do not constitute an undue limitation of the embodiments of the present disclosure.

The accompanying drawings, which are herein incorporated into and form part of the specification, illustrate embodiments consistent with the embodiments of the present disclosure and are used with the specification to explain the principles of the embodiments of the present disclosure.

FIG. 1 is a schematic diagram of a wireless communication system architecture provided by an embodiment of the present disclosure.

FIG. 2 is a flowchart of an HARQ-ACK transmission method illustrated according to an embodiment of the present disclosure.

FIG. 3 is an architectural diagram of an HARQ-ACK transmission apparatus illustrated according to an embodiment of the present disclosure.

FIG. 4 is an architectural diagram of another HARQ-ACK transmission apparatus illustrated according to an embodiment of the present disclosure.

FIG. 5 is an architectural diagram of an HARQ-ACK transmission apparatus illustrated according to an embodiment of the present disclosure.

FIG. 6 is an architectural diagram of another HARQ-ACK transmission apparatus illustrated according to an embodiment of the present disclosure.

### DETAILED DESCRIPTION

The embodiments of the present disclosure are further described in conjunction with the accompanying drawings and the detailed description.

The embodiments are described herein in detail, examples of which are represented in the accompanying drawings. When the following description relates to the accompanying drawings, the same numerals in the different accompanying drawings indicate the same or similar elements unless otherwise indicated. The embodiments described in the following embodiments do not represent all embodiments consistent with the embodiments of the present disclosure. Rather, they are only examples of apparatus and methods consistent with some aspects of the present disclosure as detailed in the appended claims.

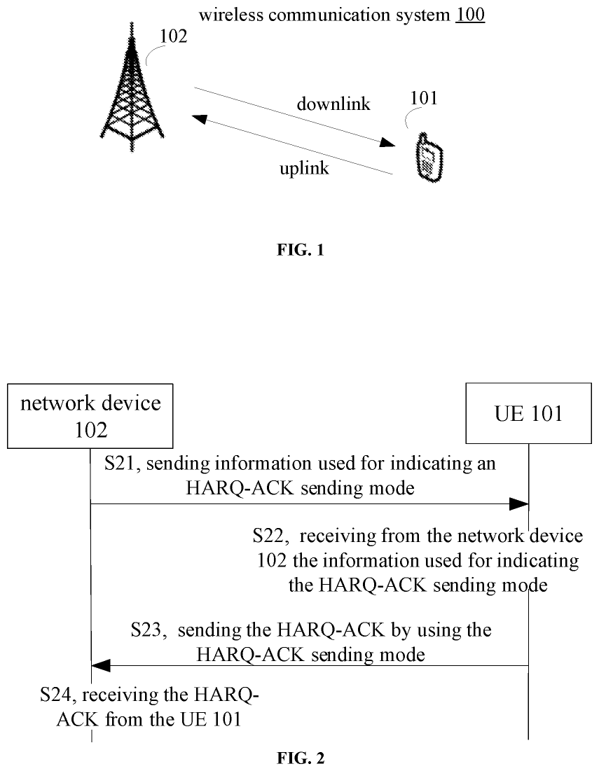

In the multi-TTI PDSCH scheduling scenario, how to effectively utilize time domain resources of the PUCCH when a UE feeds back HARQ-ACKs, on the time domain resources of the PUCCH, for a plurality of PDSCHs scheduled by one DCI is a problem that needs to be solved. As shown in FIG. 1, the HARQ-ACK transmission method provided by the embodiments of the present disclosure may be applied to a wireless communication system 100. The wireless communication system 100 may include a terminal device 101 and a network device 102. The terminal device 101 is configured to support carrier aggregation. The terminal device 101 may be connected to a plurality of carrier units of the network device 102. The carrier units include a primary carrier unit and one or more secondary carrier units.

It should be understood that the above wireless communication system 100 may be applicable to both low frequency and high frequency scenarios. Application scenarios for the wireless communication system 100 include, but are not limited to, long term evolution (LTE) systems, LTE frequency division duplex (FDD) systems, LTE time division duplex (TDD) systems, worldwide interoperability for micro wave access (WiMAX) communication systems, cloud radio access network (CRAN) systems, future fifth-generation (5G) systems, new radio (NR) communication systems, future evolved public land mobile network (PLMN) systems, etc.

The terminal device 101 shown above may be a UE, a terminal, an access terminal, a terminal unit, a terminal station, a mobile station (MS), a remote station, a remote terminal, a mobile terminal, a wireless communication device, a terminal agent, or a terminal device. The terminal device 101 may have a wireless transceiver function that enables it to communicate (e.g., wirelessly) with one or more network devices of one or more communication systems and receive network services provided by the network device. The network device herein includes but is not limited to the illustrated network device 102.

The terminal device 101 may be a cellular phone, a cordless phone, a session initiation protocol (SIP) phone, a wireless local loop (WLL) station, a personal digital assistant (PDA) device, a handheld device with wireless communication capabilities, a computing device or other processing device connected to a wireless modem, an in-vehicle device, a wearable device, a terminal device in a future 5G network or a terminal device in a future evolved PLMN network, and the like.

The network device 102 may be an access network device (or access network site). The access network device is a device that has the function of providing network access, such as a radio access network (RAN) base station, and the like. The network device 102 may specifically include a base station (BS), or include a base station and a wireless resource management device used for controlling the base station, and the like. The network device 102 may also include a relay station (a relay device), an access point, a base station in a future 5G network, a base station in a future evolved PLMN network, or an NR base station, and the like. The network device 102 may be a wearable device or an in-vehicle device. The network device 102 may also be a communication chip having a communication module.

For example, the network device 102 includes, but is not limited to, a next generation base station (gnode B, gNB) in 5G, an evolved node B (eNB) in an LTE system, a radio network controller (RNC), a node B (NB) in a WCDMA system, a wireless controller under a CRAN system, a base station controller (BSC), a base transceiver station (BTS) in a GSM system or CDMA system, a home base station (e.g., home evolved nodeB, or home node B, HNB), a baseband unit (BBU), a transmitting and receiving point (TRP), a transmitting point (TP), or a mobile switching center.

In a multi-TTI PDSCH scheduling scenario, when the UE 101 feeds back HARQ-ACKs, on the time domain resource of the PUCCH, for a plurality of PDSCHs scheduled by one DCI, the UE 101 may feed back all HARQ-ACKs on a same PUCCH for a plurality of PDSCHs scheduled by a same DCI. Specifically, a time slot, where the PUCCH used for feeding back the HARQ-ACKs for the plurality of PDSCHs is located, is determined based on the kl indicated in the DCI, and the time slot position of the last PDSCH. Adopting feedback on the same PUCCH may reduce the resource overhead, but at the same time, may bring additional feedback latency. Especially for a PDSCH with a more forward time domain position in the multi-TTI PDSCHs, the problem of large feedback latency is more serious. Therefore, adopting feedback on the same PUCCH cannot satisfy the demands of services with higher latency requirements, for example, it cannot satisfy the demands of the ultra reliable low latency communication (URLLC) service.

A manner of feedback on different PUCCHs in the multi-TTI PDSCH scheduling scenario is introduced in the present disclosure, i.e., to feed back HARQ-ACKs on different PUCCHs for a plurality of PDSCHs scheduled by a same DCI. Adopting feedback on different PUCCHs reduces the feedback latency.

The UE 101 is supported in the present disclosure to use different HARQ-ACK sending modes in different scenarios. The HARQ-ACK sending mode includes a first sending mode or a second sending mode. The first sending mode corresponds to sending a plurality of HARQ-ACKs on different PUCCHs. The second sending mode corresponds to sending a plurality of HARQ-ACKs on a same PUCCH. The UE 101 may save resource overhead when using the first sending mode, and may reduce feedback latency when using the second sending mode.

An embodiment of the present disclosure provides a HARQ-ACK transmission method. Referring to FIG. 2, FIG. 2 is a flowchart of an HARQ-ACK transmission method illustrated according to an embodiment of the present disclosure. As shown in FIG. 2, this method includes the following steps S21 to S24.

At step S21, a network device 102 sends to a UE 101 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

At step S22, the UE 101 receives from the network device 102 the information used for indicating the HARQ-ACK sending mode, and determines the HARQ-ACK sending mode based on the information used for indicating the HARQ-ACK sending mode.

At step S23, the UE 101 sends to the network device 102 the HARQ-ACK by using the HARQ-ACK sending mode.

At step S24, the network device 102 receives the HARQ-ACK from the UE 101.

In some possible embodiments, the HARQ-ACK sent by the UE 101 to the network device 102 by using the HARQ-ACK sending mode in the step S23 is a plurality of HARQ-ACKs for a plurality of PDSCHs scheduled by a same DCI.

An embodiment of the present disclosure provides a method for receiving an HARQ-ACK. This method is performed by a network device 102, and includes sending to a UE 101 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH. The method further includes receiving the HARQ-ACK from the UE 101.

In some possible embodiments, the plurality of HARQ-ACKs received by the network device 102 from the UE 101 is a plurality of HARQ-ACKs for a plurality of PDSCHs scheduled by a same DCI, i.e., the plurality of HARQ-ACKs sent by the UE 101 are a plurality of HARQ-ACKs for a plurality of PDSCHs scheduled by a same DCI.

In the embodiment of the present disclosure, the network device 102 sends to the UE 101 the information used for indicating the HARQ-ACK sending mode, causing the UE 101 to determine the HARQ-ACK sending mode as the first sending mode or the second sending mode according to the indication of the network device 102. This enables the UE 101 to adopt different HARQ-ACK sending modes for different usage scenarios, reducing the overhead of the PUCCH time domain resources while saving the feedback latency.

An embodiment of the present disclosure provides a method for receiving an HARQ-ACK. This method is performed by a network device 102, and includes sending to a UE 101 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

In this embodiment, the information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a first priority. The method further includes receiving the HARQ-ACK from the UE 101.

In some possible embodiments, the priority of the HARQ-ACK includes two priorities, specifically a high priority and a low priority. The first priority refers to the high priority.

In some possible embodiments, the priority of the HARQ-ACK includes three priorities, specifically a high priority, a medium priority and a low priority. The first priority refers to the high priority.

In some possible embodiments, the priority of the HARQ-ACK includes more than three priorities. The first priority refers to the highest priority.

In some possible embodiments, the first priority refers to the highest priority of the plurality of priorities of the HARQ-ACK.

In the embodiment of the present disclosure, the network device 102 sends to the UE 101 the first auxiliary information used for determining the HARQ-ACK sending mode, and the first auxiliary information indicates that the first sending mode is used for the HARQ-ACK with the first priority, causing the UE 101 to determine based on this indication, after determining the priority of the HARQ-ACK, whether the priority of the HARQ-ACK conforms to the first priority required by the first auxiliary information. The UE 101 determines that the first sending mode is used when the priority of the HARQ-ACK conforms to the first priority required by the first auxiliary information, and determines that the second sending mode is used when the priority of the HARQ-ACK does not conform to the first priority required by the first auxiliary information. Thus, an HARQ-ACK sending mode that meets the requirements of the network device 102 is selected.

An embodiment of the present disclosure provides a method for receiving an HARQ-ACK. This method is performed by a network device 102, and includes sending to a UE 101 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

In this embodiment, the information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a priority higher than a first priority.

The method further includes receiving the HARQ-ACK from the UE 101.

In some possible embodiments, the priority of the HARQ-ACK includes three priorities, specifically a high priority, a medium priority and a low priority. The first priority is the medium priority.

In some possible embodiments, the priority of the HARQ-ACK includes more than three priorities. The first priority is the second highest priority; or the first priority is a priority other than the highest priority, the lowest priority, and the second highest priority.

In some possible embodiments, the first priority is the second highest priority of the plurality of priorities of the HARQ-ACK.

In the embodiment of the present disclosure, the network device 102 sends to the UE 101 the first auxiliary information used for determining the HARQ-ACK sending mode, and the first auxiliary information indicates that the first sending mode is used for the HARQ-ACK with a priority higher than the first priority, causing the UE 101 to determine based on this indication, after determining the priority of the HARQ-ACK, whether the priority of the HARQ-ACK conforms to the priority required by the first auxiliary information. The UE 101 determines that the first sending mode is used when the priority of the HARQ-ACK conforms to the priority required by the first auxiliary information, and determines that the second sending mode is used when the priority of the HARQ-ACK does not conform to the priority required by the first auxiliary information. Thus, an HARQ-ACK sending mode that meets the requirements of the network device 102 is selected.

An embodiment of the present disclosure provides a method for receiving an HARQ-ACK. This method is performed by a network device 102, and includes sending to a UE 101 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

In this embodiment, the information used for indicating the HARQ-ACK sending mode includes first auxiliary information used for determining the HARQ-ACK sending mode and second auxiliary information used for determining the HARQ-ACK sending mode. The first auxiliary information is information, in a higher layer signaling, indicating that the first sending mode is used for an HARQ-ACK with a first priority. The second auxiliary information is priority information indicated by a priority indication information field in a DCI. The priority information is priorities of HARQ-ACKs corresponding to a plurality of PDSCHs scheduled by the DCI.

The method further includes receiving the HARQ-ACK from the UE 101.

In a possible embodiment, a priority indicated by the second auxiliary information is the first priority, equivalent to indicating the UE to use the first sending mode.

In a possible embodiment, a priority indicated by the second auxiliary information is not the first priority, equivalent to indicating the UE to use the second sending mode.

In the embodiment of the present disclosure, the network device 102 sends to the UE 101 the first auxiliary information and the second auxiliary information used for determining the HARQ-ACK sending mode. The first auxiliary information indicates that the first sending mode is used for the HARQ-ACK with the first priority. The second auxiliary information indicates the priorities of the HARQ-ACKs corresponding to the plurality of PDSCHs scheduled by the DCI. Thus, the UE 101 is enabled to select a suitable HARQ-ACK sending mode based on the selection condition of the priority of the HARQ-ACK corresponding to the first sending mode indicated by the first auxiliary information and the priority indicated by the second auxiliary information.

The following is illustrated by two specific examples.

### Example 1

Priorities of HARQ-ACKs corresponding to a plurality of PDSCHs scheduled by a same DCI include two priorities, and the two priorities include a high priority and a low priority.

The network device 102 sends the first auxiliary information and the second auxiliary information to the UE 101. Herein, the first auxiliary information indicates that the first sending mode is used for an HARQ-ACK with the high priority, and the second auxiliary information indicates that priorities of the HARQ-ACKs corresponding to the plurality of PDSCHs scheduled by the DCI are the high priorities. The UE 101 determines to use the first sending mode based on the first auxiliary information and the second auxiliary information.

### Example 2

Priorities of HARQ-ACKs corresponding to a plurality of PDSCHs scheduled by a same DCI include two priorities, and the two priorities include a high priority and a low priority.

The network device 102 sends the first auxiliary information and the second auxiliary information to the UE 101. Herein, the first auxiliary information indicates that the first sending mode is used for an HARQ-ACK with the high priority, and the second auxiliary information indicates that the priorities of the HARQ-ACKs corresponding to the plurality of PDSCHs scheduled by the DCI are all of the low priorities. The UE 101 determines to use the second sending mode based on the first auxiliary information and the second auxiliary information.

An embodiment of the present disclosure provides a method for receiving an HARQ-ACK. This method is performed by a network device 102, and includes sending to a UE 101 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

In this embodiment, the information used for indicating the HARQ-ACK sending mode includes first auxiliary information used for determining the HARQ-ACK sending mode and second auxiliary information used for determining the HARQ-ACK sending mode. The first auxiliary information is information, in a higher layer signaling, indicating that the first sending mode is used for an HARQ-ACK with a priority higher than a first priority. The second auxiliary information is priority information indicated by a priority indication information field in a DCI. The priority information is priorities of HARQ-ACKs corresponding to a plurality of PDSCHs scheduled by the DCI.

The method further includes receiving the HARQ-ACK from the UE 101.

In the embodiment of the present disclosure, the network device 102 sends to the UE 101 the first auxiliary information and the second auxiliary information used for determining the HARQ-ACK sending mode. The first auxiliary information indicates that the first sending mode is used for the HARQ-ACK with a priority higher than the first priority. The second auxiliary information indicates the priorities of the HARQ-ACKs corresponding to the plurality of PDSCHs scheduled by the DCI. Thus, the UE 101 is enabled to select a suitable HARQ-ACK sending mode based on the selection condition of the priority of the HARQ-ACK corresponding to the first sending mode indicated by the first auxiliary information and the priority indicated by the second auxiliary information.

The following is illustrated by two specific examples.

### Example 3

Priorities of HARQ-ACKs corresponding to a plurality of PDSCHs scheduled by a same DCI include three priorities, and the three priorities include a high priority, a medium priority and a low priority.

The network device 102 sends the first auxiliary information and the second auxiliary information to the UE 101. Herein, the first auxiliary information indicates that the first sending mode is used for an HARQ-ACK with a priority higher than the medium priority, and the second auxiliary information indicates that priorities of the HARQ-ACKs corresponding to the plurality of PDSCHs scheduled by the DCI are all of the high priorities. The UE 101 determines to use the first sending mode based on the first auxiliary information and the second auxiliary information.

### Example 4

Priorities of HARQ-ACKs corresponding to a plurality of PDSCHs scheduled by a same DCI include three priorities, and the three priorities include a high priority, a medium priority and a low priority.

The network device 102 sends the first auxiliary information and the second auxiliary information to the UE 101. Herein, the first auxiliary information indicates that the first sending mode is used for an HARQ-ACK with a priority higher than the medium priority, and the second auxiliary information indicates that the priorities of the HARQ-ACKs corresponding to the plurality of PDSCHs scheduled by the DCI are all of the low priorities. The UE 101 determines to use the second sending mode based on the first auxiliary information and the second auxiliary information.

An embodiment of the present disclosure provides a method for receiving an HARQ-ACK. This method is performed by a network device 102, and includes sending to a UE 101 information used for indicating the first sending mode. The information used for indicating the first sending mode is first indication information in a higher layer signaling. The first indication information is used for indicating that the first sending mode is used for an HARQ-ACK with any priority. The method further includes receiving from the UE 101 the HARQ-ACK sent by using the first sending mode.

In the embodiment of the present disclosure, the network device 102 sends the first indication information to the UE via the higher layer signaling, and the first indication information is used for indicating that the first sending mode is used for an HARQ-ACK with any priority. In this case, regardless of whether a priority indication is included in the DCI, or, regardless of the specific priority of a priority indication when the priority indication is included in the DCI, the UE 101 may directly determine, based on the higher layer signaling, to use the first sending mode.

An embodiment of the present disclosure provides a method for receiving an HARQ-ACK. This method is performed by a network device 102, and includes sending to a UE 101 information used for indicating the second sending mode. The information used for indicating the second sending mode is a higher layer signaling not including first auxiliary information. The first auxiliary information is used for indicating that the first sending mode is used for an HARQ-ACK with a first priority, or used for indicating that the first sending mode is used for an HARQ-ACK with a priority higher than the first priority. The method further includes receiving from the UE 101 the HARQ-ACK sent by using the second sending mode.

In the embodiment of the present disclosure, the network device 102 indicates, by sending the higher layer signaling without carrying the first auxiliary information, the UE 101 to use the second sending mode.

An embodiment of the present disclosure provides a method for receiving an HARQ-ACK. This method is performed by a network device 102, and includes sending to a UE 101 a higher layer signaling. The higher layer signaling does not include first auxiliary information. The first auxiliary information is used for indicating that the first sending mode is used for an HARQ-ACK with a first priority, or used for indicating that the first sending mode is used for an HARQ-ACK with a priority higher than the first priority. The method further includes receiving from the UE 101 the HARQ-ACK sent by using the second sending mode.

In the embodiment of the present disclosure, the network device 102 indicates, by sending the higher layer signaling not including the first auxiliary information to the UE, the UE 101 to use the second sending mode.

An embodiment of the present disclosure provides a method for receiving an HARQ-ACK. This method is performed by a network device 102, and includes sending to a UE 101 information used for indicating the second sending mode. The information used for indicating the second sending mode is second indication information in a higher layer signaling. The second indication information is used for indicating that the first sending mode is disabled for an HARQ-ACK with a first priority, or used for indicating that the first sending mode is disabled for an HARQ-ACK with a priority higher than the first priority. The method further includes receiving from the UE 101 the HARQ-ACK sent by using the second sending mode.

In the embodiment of the present disclosure, the network device 102 indicates, by sending the higher layer signaling carrying the second indication information, the UE 101 to use the second sending mode.

An embodiment of the present disclosure provides a method for receiving an HARQ-ACK. This method is performed by a network device 102, and includes sending to a UE 101 a higher layer signaling. The higher layer signaling includes second indication information. The second indication information is used for indicating that the first sending mode is disabled for an HARQ-ACK with a first priority, or used for indicating that the first sending mode is disabled for an HARQ-ACK with a priority higher than the first priority. The method further includes receiving from the UE 101 the HARQ-ACK sent by using the second sending mode.

In the embodiment of the present disclosure, the network device 102 indicates, by sending the higher layer signaling to the UE 101 and indicating the second indication information in the higher layer signaling, the UE 101 to use the second sending mode.

An embodiment of the present disclosure provides a method for receiving an HARQ-ACK. This method is performed by a network device 102, and includes sending to a UE 101 information used for indicating the second sending mode. The information used for indicating the second sending mode is a higher layer signaling not including first indication information. The first indication information is used for indicating that the first sending mode is used for an HARQ-ACK with any priority. The method further includes receiving from the UE 101 the HARQ-ACK sent by using the second sending mode.

In the embodiment of the present disclosure, the network device 102 indicates, by sending the higher layer signaling without carrying the first indication information, the UE 101 to use the second sending mode.

An embodiment of the present disclosure provides a method for receiving an HARQ-ACK. This method is performed by a network device 102, and includes sending to a UE 101 a higher layer signaling. The higher layer signaling does not include first indication information. The first indication information is used for indicating that the first sending mode is used for an HARQ-ACK with any priority. The method further includes receiving from the UE 101 the HARQ-ACK sent by using the second sending mode.

In the embodiment of the present disclosure, the network device 102 indicates, by sending the higher layer signaling not including the first indication information to the UE 101, the UE 101 to use the second sending mode.

An embodiment of the present disclosure provides a method for receiving an HARQ-ACK. This method is performed by a network device 102, and includes sending to a UE 101 information used for indicating the second sending mode. The information used for indicating the second sending mode is third indication information in a higher layer signaling. The third indication information is used for indicating that the first sending mode is disabled for an HARQ-ACK with any priority. The method further includes receiving from the UE 101 the HARQ-ACK sent by using the second sending mode.

In the embodiment of the present disclosure, the network device 102 indicates, by sending the higher layer signaling and carrying the third indication information in the higher layer signaling, the UE 101 to use the second sending mode.

An embodiment of the present disclosure provides a method for receiving an HARQ-ACK. This method is performed by a network device 102, and includes sending to a UE 101 a higher layer signaling. The higher layer signaling includes third indication information. The third indication information is used for indicating that the first sending mode is disabled for an HARQ-ACK with any priority. The method further includes receiving from the UE 101 the HARQ-ACK sent by using the second sending mode.

In the embodiment of the present disclosure, the network device 102 indicates, by sending the higher layer signaling and carrying the third indication information in the higher layer signaling, the UE 101 to use the second sending mode.

An embodiment of the present disclosure provides a method for sending an HARQ-ACK. This method is performed by a UE 101, and includes receiving from a network device 102 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH. The method further includes determining the HARQ-ACK sending mode based on the information used for indicating the HARQ-ACK sending mode, and sending the HARQ-ACK to the network device by using the HARQ-ACK sending mode.

In some possible embodiments, the plurality of HARQ-ACKs sent by the UE 101 are a plurality of HARQ-ACKs for a plurality of PDSCHs scheduled by a same DCI, i.e., the plurality of HARQ-ACKs received by the network device 102 are a plurality of HARQ-ACKs for a plurality of PDSCHs scheduled by a same DCI.

In the embodiment of the present disclosure, the UE 101 receives from the network device 102 the information used for indicating the HARQ-ACK sending mode, and determines the HARQ-ACK sending mode as the first sending mode or the second sending mode according to the indication of the network device 102. This enables the UE 101 to adopt different HARQ-ACK sending modes for different usage scenarios, reducing the overhead of the PUCCH time domain resources while saving the feedback latency.

An embodiment of the present disclosure provides a method for sending an HARQ-ACK. This method is performed by a UE 101, and includes receiving from a network device 102 information used for indicating an HARQ-ACK sending mode. The information used for indicating the HARQ-ACK sending mode includes a higher layer signaling. The higher layer signaling includes first auxiliary information used for determining the HARQ-ACK sending mode. The first auxiliary information is information indicating that the first sending mode is used for an HARQ-ACK with a first priority.

The method further includes determining the HARQ-ACK sending mode based on the first auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 information used for indicating an HARQ-ACK sending mode. The information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a first priority.

The method further includes determining the HARQ-ACK sending mode based on the first auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 a higher layer signaling. The higher layer signaling includes first auxiliary information used for determining the HARQ-ACK sending mode. The first auxiliary information is information indicating that the first sending mode is used for an HARQ-ACK with a first priority.

The method further includes determining the HARQ-ACK sending mode based on the first auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 information used for indicating an HARQ-ACK sending mode. The information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a priority higher than a first priority.

The method further includes determining the HARQ-ACK sending mode based on the first auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 a higher layer signaling. The higher layer signaling includes first auxiliary information used for determining the HARQ-ACK sending mode. The first auxiliary information is information indicating that the first sending mode is used for an HARQ-ACK with a priority higher than a first priority.

The method further includes determining the HARQ-ACK sending mode based on the first auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 first auxiliary information used for determining the HARQ-ACK sending mode. The first auxiliary information is information, in a higher layer signaling, indicating that the first sending mode is used for an HARQ-ACK with a first priority; or the first auxiliary information is information, in the higher layer signaling, indicating that the first sending mode is used for an HARQ-ACK with a priority higher than the first priority.

The method further includes receiving from the network device 102 second auxiliary information used for determining the HARQ-ACK sending mode. The second auxiliary information used for determining the HARQ-ACK sending mode is priority information indicated by a priority indication information field in a DCI. The priority information is priorities of HARQ-ACKs corresponding to a plurality of PDSCHs scheduled by the DCI.

The method further includes determining the HARQ-ACK sending mode based on the first auxiliary information and the second auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 a higher layer signaling. The higher layer signaling includes first auxiliary information used for determining the HARQ-ACK sending mode. The first auxiliary information is information indicating that the first sending mode is used for an HARQ-ACK with a first priority, or the first auxiliary information is information indicating that the first sending mode is used for an HARQ-ACK with a priority higher than the first priority.

The method further includes receiving from the network device 102 a DCI. The DCI includes second auxiliary information used for determining the HARQ-ACK sending mode. The second auxiliary information is priority information indicated by a priority indication information field in the DCI. The priority information is priorities of HARQ-ACKs corresponding to a plurality of PDSCHs scheduled by the DCI.

The method further includes determining the HARQ-ACK sending mode based on the first auxiliary information and the second auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 a higher layer signaling. The higher layer signaling includes first auxiliary information used for determining the HARQ-ACK sending mode. The first auxiliary information is information indicating that the first sending mode is used for an HARQ-ACK with a first priority, or the first auxiliary information is information indicating that the first sending mode is used for an HARQ-ACK with a priority higher than the first priority.

The method further includes receiving from the network device 102 a DCI. The DCI includes second auxiliary information used for determining the HARQ-ACK sending mode. The second auxiliary information is priority information indicated by a priority indication information field in the DCI. The priority information is priorities of HARQ-ACKs corresponding to a plurality of PDSCHs scheduled by the DCI.

The method further includes determining the HARQ-ACK sending mode based on the first auxiliary information and the second auxiliary information. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

In this embodiment, the determining the HARQ-ACK sending mode based on the first auxiliary information and the second auxiliary information includes one of:
when the first auxiliary information is the information, in the higher layer signaling, indicating that the first sending mode is used for the HARQ-ACK with the first priority, and a priority corresponding to the second auxiliary information is the first priority, determining the HARQ-ACK sending mode is the first sending mode;
when the first auxiliary information is the information, in the higher layer signaling, indicating that the first sending mode is used for the HARQ-ACK with the first priority, and the priority corresponding to the second auxiliary information is not the first priority, determining the HARQ-ACK sending mode is the second sending mode;
when the first auxiliary information is the information, in the higher layer signaling, indicating that the first sending mode is used for the HARQ-ACK with a priority higher than the first priority, and the priority corresponding to the second auxiliary information is higher than the first priority, determining the HARQ-ACK sending mode is the first sending mode; or
when the first auxiliary information is the information, in the higher layer signaling, indicating that the first sending mode is used for the HARQ-ACK with a priority higher than the first priority, and the priority corresponding to the second auxiliary information is lower than or equal to the first priority, determining the HARQ-ACK sending mode is the second sending mode.

The method further includes sending the HARQ-ACK to the network device by using the HARQ-ACK sending mode.

An embodiment of the present disclosure provides a method for sending an HARQ-ACK. This method is performed by a UE 101, and includes receiving from a network device 102 information used for indicating an HARQ-ACK sending mode. The information used for indicating the HARQ-ACK sending mode includes information used for indicating the first sending mode. The information used for indicating the first sending mode is first indication information in a higher layer signaling. The first indication information is used for indicating that the first sending mode is used for an HARQ-ACK with any priority.

The method further includes determining that the HARQ-ACK sending mode is the first sending mode, and sending the HARQ-ACK to the network device by using the first sending mode.

An embodiment of the present disclosure provides a method for sending an HARQ-ACK. This method is performed by a UE 101, and includes receiving from a network device 102 a higher layer signaling. The higher layer signaling includes first indication information. The first indication information is used for indicating that the first sending mode is used for an HARQ-ACK with any priority.

The method further includes determining that the HARQ-ACK sending mode is the first sending mode, and sending the HARQ-ACK to the network device by using the first sending mode.

An embodiment of the present disclosure provides a method for sending an HARQ-ACK. This method is performed by a UE 101, and includes receiving from a network device 102 information used for indicating an HARQ-ACK sending mode. The information used for indicating the HARQ-ACK sending mode includes information used for indicating the second sending mode. The information used for indicating the second sending mode is a higher layer signaling not including first auxiliary information. The first auxiliary information is used for indicating that the first sending mode is used for an HARQ-ACK with a first priority, or used for indicating that the first sending mode is used for an HARQ-ACK with a priority higher than the first priority.

The method further includes determining that the HARQ-ACK sending mode is the second sending mode, and sending the HARQ-ACK to the network device by using the second sending mode.

An embodiment of the present disclosure provides a method for sending an HARQ-ACK. This method is performed by a UE 101, and includes receiving from a network device 102 a higher layer signaling. The higher layer signaling does not include first auxiliary information used for determining the HARQ-ACK sending mode. The first auxiliary information is used for indicating that the first sending mode is used for an HARQ-ACK with a first priority, or used for indicating that the first sending mode is used for an HARQ-ACK with a priority higher than the first priority.

The method further includes determining that the HARQ-ACK sending mode is the second sending mode, and sending the HARQ-ACK to the network device by using the second sending mode.

An embodiment of the present disclosure provides a method for sending an HARQ-ACK. This method is performed by a UE 101, and includes receiving from a network device 102 information used for indicating an HARQ-ACK sending mode. The information used for indicating the HARQ-ACK sending mode includes information used for indicating the second sending mode. The information used for indicating the second sending mode is second indication information in a higher layer signaling. The second indication information is used for indicating that the first sending mode is disabled for an HARQ-ACK with a first priority, or used for indicating that the first sending mode is disabled for an HARQ-ACK with a priority higher than the first priority.

The method further includes determining that the HARQ-ACK sending mode is the second sending mode, and sending the HARQ-ACK to the network device by using the second sending mode.

An embodiment of the present disclosure provides a method for sending an HARQ-ACK. This method is performed by a UE 101, and includes receiving from a network device 102 a higher layer signaling. The higher layer signaling includes second indication information. The second indication information is used for indicating that the first sending mode is disabled for an HARQ-ACK with a first priority, or used for indicating that the first sending mode is disabled for an HARQ-ACK with a priority higher than the first priority.

The method further includes determining that the HARQ-ACK sending mode is the second sending mode, and sending the HARQ-ACK to the network device by using the second sending mode.

An embodiment of the present disclosure provides a method for sending an HARQ-ACK. This method is performed by a UE 101, and includes receiving from a network device 102 information used for indicating an HARQ-ACK sending mode. The information used for indicating the HARQ-ACK sending mode is a higher layer signaling not including first indication information. The first indication information is used for indicating that the first sending mode is used for an HARQ-ACK with any priority.

The method further includes determining that the HARQ-ACK sending mode is the second sending mode, and sending the HARQ-ACK to the network device by using the second sending mode.

An embodiment of the present disclosure provides a method for sending an HARQ-ACK. This method is performed by a UE 101, and includes receiving from a network device 102 a higher layer signaling. The higher layer signaling does not include first indication information. The first indication information is used for indicating that the first sending mode is used for an HARQ-ACK with any priority.

The method further includes determining that the HARQ-ACK sending mode is the second sending mode, and sending the HARQ-ACK to the network device by using the second sending mode.

An embodiment of the present disclosure provides a method for sending an HARQ-ACK. This method is performed by a UE 101, and includes receiving from a network device 102 information used for indicating the HARQ-ACK sending mode. The information used for indicating the HARQ-ACK sending mode is third indication information in a higher layer signaling. The third indication information is used for indicating that the first sending mode is disabled for an HARQ-ACK with any priority.

The method further includes determining that the HARQ-ACK sending mode is the second sending mode, and sending the HARQ-ACK to the network device by using the second sending mode.

An embodiment of the present disclosure provides a method for sending an HARQ-ACK. This method is performed by a UE 101, and includes receiving from a network device 102 a higher layer signaling. The higher layer signaling includes third indication information. The third indication information is used for indicating that the first sending mode is disabled for an HARQ-ACK with any priority.

The method further includes determining that the HARQ-ACK sending mode is the second sending mode, and sending the HARQ-ACK to the network device by using the second sending mode.

An embodiment of the present disclosure provides a communication device based on the same conceptualization as the above method embodiments. The communication device may have the function of the network device 102 in the above method embodiments and may be configured to execute the steps performed by the network device 102 provided by the above method embodiments. The function may be implemented by hardware, or may be implemented by software or hardware executing corresponding software. The hardware or software includes one or more modules corresponding to the function described above.

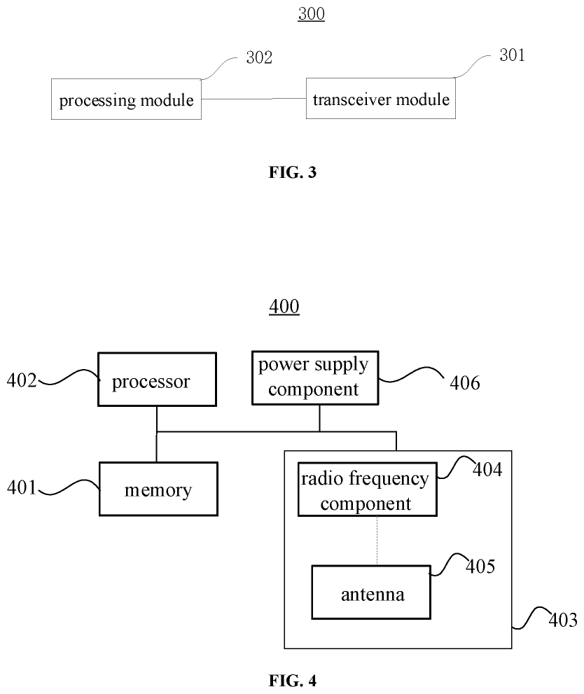

In one possible implementation, the communication device 300, as shown in FIG. 3, may act as the network device involved in the above method embodiments and execute the steps performed by the network device in the above method embodiments. As shown in FIG. 3, the communication device 300 may include a transceiver module 301 and a processing module 302. The transceiver module 301 and the processing module 302 are coupled to each other. The transceiver module 301 may be configured to support the communication device 300 for communication. The transceiver module 301 may have a wireless communication function, such as being able to communicate wirelessly with other communication devices via a wireless air interface. The processing module 302 may be configured to support the communication device 300 for performing the processing actions in the method embodiments described above, including but not limited to, generating information or messages sent by the transceiver module 301, and/or, demodulating and decoding a signal received by the transceiver module 301, and the like.

In executing the steps implemented by the network device 102, the transceiver module 301 is configured to send to a UE 101 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH. The transceiver module 301 is further configured to receive the HARQ-ACK from the UE 101.

Optionally, the information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a first priority.

Optionally, the information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a priority higher than a first priority.

Optionally, the information used for indicating the HARQ-ACK sending mode further includes second auxiliary information used for determining the HARQ-ACK sending mode. The second auxiliary information is priority information indicated by a priority indication information field in a DCI. The priority information is priorities of HARQ-ACKs corresponding to a plurality of PDSCHs scheduled by the DCI.

Optionally, the information used for indicating the HARQ-ACK sending mode includes information used for indicating the first sending mode. The information used for indicating the first sending mode is first indication information in a higher layer signaling. The first indication information is used for indicating that the first sending mode is used for an HARQ-ACK with any priority.

Optionally, the information used for indicating the HARQ-ACK sending mode includes information used for indicating the second sending mode. The information used for indicating the second sending mode is a higher layer signaling not including first auxiliary information. The first auxiliary information is used for indicating that the first sending mode is used for an HARQ-ACK with a first priority, or used for indicating that the first sending mode is used for an HARQ-ACK with a priority higher than the first priority.

Optionally, the information used for indicating the HARQ-ACK sending mode includes information used for indicating the second sending mode. The information used for indicating the second sending mode is second indication information in a higher layer signaling. The second indication information is used for indicating that the first sending mode is disabled for an HARQ-ACK with a first priority, or used for indicating that the first sending mode is disabled for an HARQ-ACK with a priority higher than the first priority.

Optionally, the information used for indicating the HARQ-ACK sending mode includes information used for indicating the second sending mode. The information used for indicating the second sending mode is a higher layer signaling not including first indication information. The first indication information is used for indicating that the first sending mode is used for an HARQ-ACK with any priority.

Optionally, the information used for indicating the HARQ-ACK sending mode includes information used for indicating the second sending mode. The information used for indicating the second sending mode is third indication information in a higher layer signaling. The third indication information is used for indicating that the first sending mode is disabled for an HARQ-ACK with any priority.

When the communication device is the network device 102, the structure of the communication device may also be shown in FIG. 4. Using a base station as an example to illustrate the structure of the communication device. As shown in FIG. 4, the device 400 includes a memory 401, a processor 402, a transceiver component 403, and a power supply component 406. The memory 401 is coupled with the processor 402, and may be configured to store programs and data necessary for the communication device 400 to implement various functions. The processor 402 is configured to support the communication device 400 for performing the corresponding functions in the above methods, and the functions may be implemented by calling the programs stored in the memory 401. The transceiver component 403 may be a wireless transceiver, and may be configured to support the communication device 400 for receiving a signaling and/or data via a wireless air interface, and sending a signaling and/or data. The transceiver component 403 may also be referred to as a transceiver unit or communication unit. The transceiver component 403 may include a radio frequency component 404 and one or more antennas 405. The radio frequency component 404 may be a remote radio unit (RRU), which may be configured for transmission of radio frequency signals and conversion between radio frequency signals and baseband signals. The one or more antennas 405 may be configured for radiation and reception of the radio frequency signals.

When the communication device 400 needs to send data, the processor 402 may perform baseband processing on the data to be sent and output a baseband signal to the radio frequency unit. The radio frequency unit performs radio frequency processing on the baseband signal and sends the radio frequency signal in the form of electromagnetic waves through the antenna. When data is sent to the communication device 400, the radio frequency unit receives the radio frequency signal through the antenna, converts the radio frequency signal into the baseband signal, and outputs the baseband signal to the processor 402. The processor 402 converts the baseband signal into data and processes the data.

An embodiment of the present disclosure provides a communication device based on the same conceptualization as the above method embodiments. The communication device may have the function of the UE 101 in the above method embodiments and may be configured to execute the steps performed by the UE 101 provided by the above method embodiments. The function may be implemented by hardware, or may be implemented by software or hardware executing corresponding software. The hardware or software includes one or more modules corresponding to the function described above.

In one possible implementation, the communication device 500, as shown in FIG. 5, may act as the UE involved in the above method embodiments and execute the steps performed by the UE in the above method embodiments. As shown in FIG. 5, the communication device 500 may include a transceiver module 501 and a processing module 502. The transceiver module 501 and the processing module 502 are coupled to each other. The transceiver module 501 may be configured to support the communication device 500 for communication. The transceiver module 501 may have a wireless communication function, such as being able to communicate wirelessly with other communication devices via a wireless air interface. The processing module 502 may be configured to support the communication device 500 for performing the processing actions in the method embodiments described above, including but not limited to, generating information or messages sent by the transceiver module 501, and/or, demodulating and decoding a signal received by the transceiver module 501, and the like.

In executing the steps implemented by the UE 101, the transceiver module 501 is configured to receive from a network device 102 information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The processing module 502 is configured to determine the HARQ-ACK sending mode based on the information used for indicating the HARQ-ACK sending mode.

The transceiver module 501 is further configured to send the HARQ-ACK to the network device by using the HARQ-ACK sending mode.

Optionally, the transceiver module 501 is specifically configured to receive from the network device first auxiliary information used for determining the HARQ-ACK sending mode. The first auxiliary information is information, in a higher layer signaling, indicating that the first sending mode is used for an HARQ-ACK with a first priority. Optionally, the transceiver module 501 is specifically configured to receive from the network device first auxiliary information used for determining the HARQ-ACK sending mode. The first auxiliary information is information, in a higher layer signaling, indicating that the first sending mode is used for an HARQ-ACK with a priority higher than a first priority

Optionally, the transceiver module 501 is specifically configured to receive from the network device second auxiliary information used for determining the HARQ-ACK sending mode. The second auxiliary information used for determining the HARQ-ACK sending mode is priority information indicated by a priority indication information field in a DCI. The priority information is priorities of HARQ-ACKs corresponding to a plurality of PDSCHs scheduled by the DCI.

Optionally, the processing module 502 is specifically configured to determine the HARQ-ACK sending mode based on the first auxiliary information and the second auxiliary information.

Optionally, the processing module 502 is specifically configured to determine the HARQ-ACK sending mode based on the first auxiliary information and the second auxiliary information by using one of the following means:
when the first auxiliary information is the information, in the higher layer signaling, indicating that the first sending mode is used for the HARQ-ACK with the first priority, and a priority corresponding to the second auxiliary information is the first priority, determining the HARQ-ACK sending mode is the first sending mode;
when the first auxiliary information is the information, in the higher layer signaling, indicating that the first sending mode is used for the HARQ-ACK with the first priority, and the priority corresponding to the second auxiliary information is not the first priority, determining the HARQ-ACK sending mode is the second sending mode;
when the first auxiliary information is the information, in the higher layer signaling, indicating that the first sending mode is used for the HARQ-ACK with a priority higher than the first priority, and the priority corresponding to the second auxiliary information is higher than the first priority, determining the HARQ-ACK sending mode is the first sending mode; or
when the first auxiliary information is the information, in the higher layer signaling, indicating that the first sending mode is used for the HARQ-ACK with a priority higher than the first priority, and the priority corresponding to the second auxiliary information is lower than or equal to the first priority, determining the HARQ-ACK sending mode is the second sending mode.

Optionally, the processing module 502 is specifically configured to determine, in response to the information used for indicating the HARQ-ACK sending mode being first indication information in a higher layer signaling, that the HARQ-ACK sending mode is the first sending mode. The first indication information is used for indicating that the first sending mode is used for an HARQ-ACK with any priority.

Optionally, the processing module 502 is specifically configured to determine, in response to the information used for indicating the HARQ-ACK sending mode being a higher layer signaling not including first auxiliary information used for determining the HARQ-ACK sending mode, that the HARQ-ACK sending mode is the second sending mode. The first auxiliary information is used for indicating that the first sending mode is used for an HARQ-ACK with a first priority.

Optionally, the processing module 502 is specifically configured to determine, in response to the information used for indicating the HARQ-ACK sending mode being second indication information in a higher layer signaling, that the HARQ-ACK sending mode is the second sending mode. The second indication information is used for indicating that the first sending mode is disabled for an HARQ-ACK with a first priority, or used for indicating that the first sending mode is disabled for an HARQ-ACK with a priority higher than the first priority.

Optionally, the processing module 502 is specifically configured to determine, in response to the information used for indicating the HARQ-ACK sending mode being a higher layer signaling not including first indication information, that the HARQ-ACK sending mode is the second sending mode. The first indication information is used for indicating that the first sending mode is used for an HARQ-ACK with any priority.

Optionally, the processing module 502 is specifically configured to determine, in response to the information used for indicating the HARQ-ACK sending mode being third indication information in a higher layer signaling, that the HARQ-ACK sending mode is the second sending mode. The third indication information is used for indicating that the first sending mode is disabled for an HARQ-ACK with any priority.

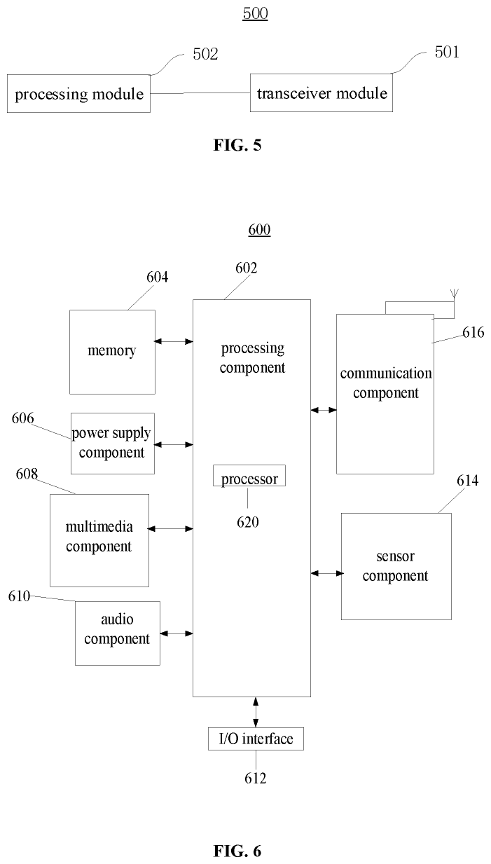

When the communication device is the UE 101, the structure of the communication device may also be shown in FIG. 6. The device 600 can be a mobile phone, computer, digital broadcasting terminal, messaging device, game console, tablet device, medical device, fitness device, personal digital assistant, etc.

Referring to FIG. 6, the device 600 may include one or more of the following components: a processing component 602, a memory 604, a power supply component 606, a multimedia component 608, an audio component 610, an input/output (I/O) interface 612, a sensor component 614, and a communication component 616.

The processing component 602 generally controls the overall operation of the device 600, such as operations associated with display, telephone calls, data communication, camera operations, and recording operations. The processing component 602 may include one or more processors 620 to execute an instruction to complete all or some of the steps of the methods described above. In addition, the processing component 602 may include one or more modules that facilitate interaction between the processing component 602 and other components. For example, the processing component 602 may include a multimedia module to facilitate interaction between the multimedia component 608 and the processing component 602.

The memory 604 is configured to store various types of data to support the operations at the device 600. Examples of such data include the following for any application or method to operate on the device 600: instructions, contact data, phonebook data, messages, pictures, videos, etc. The memory 604 may be implemented by any type of volatile or non-volatile storage device or a combination thereof, such as a static random access memory (SRAM), electrically erasable programmable read-only memory (EEPROM), erasable programmable read-only memory (EPROM), programmable read-only memory (PROM), read-only memory (ROM), magnetic memory, flash memory, disk or CD-ROM.

The power supply component 606 supplies power to various components of the device 600. The power supply component 606 may include a power supply management system, one or more power supplies, and other components associated with generating, managing, and distributing power for the device 600.

The multimedia component 608 includes a screen that provides an output interface between the device 600 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe action. In some embodiments, the multimedia component 608 includes a front-facing camera and/or a rear-facing camera. The front-facing camera and/or the rear-facing camera may receive external multimedia data when the device 600 is in an operating mode, such as a shooting mode or a video mode. Each of the front-facing camera and the rear-facing camera may be a fixed optical lens system or have a focal length and optical zoom capability.

The audio component 610 is configured to output and/or input audio signals. For example, the audio component 610 includes a microphone (MIC), configured to receive external audio signals when the device 600 is in an operating mode, such as a calling mode, a recording mode, and a voice recognition mode. The received audio signals may be further stored in the memory 604 or sent via the communication component 616. In some embodiments, the audio component 610 further includes a speaker for outputting the audio signals.

The I/O interface 612 provides an interface between the processing component 602 and a peripheral interface module, and the peripheral interface module may be a keypad, a click wheel, a button, etc. These buttons may include, but are not limited to, a home button, a volume button, a start button, and a lock button.

The sensor component 614 includes one or more sensors, configured to provide a status assessment of various aspects of the device 600. For example, the sensor component 614 may detect an open/closed state of the device 600, relative positioning of the components, for example, the components are the display and keypad of the device 600, the sensor component 614 may also detect a change in the position of the device 600 or a change in the position of one component of the device 600, the presence or absence of user contact with the device 600, the orientation or acceleration/deceleration of the device 600, and temperature changes of the device 600. The sensor component 614 may include a proximity sensor, configured to detect the presence of nearby objects in the absence of any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate the communication between the device 600 and other devices by wired or wireless means. The device 600 may access a wireless network based on a communication standard, such as Wi-Fi, 2G, 3G, or a combination thereof. In an embodiment, the communication component 616 receives broadcast signals or broadcast-related information from an external broadcast management system via a broadcast channel. In an embodiment, the communication component 616 further includes a near-field communication (NFC) module to facilitate short-range communication. For example, the NFC module may be implemented based on a radio frequency identification (RFID) technology, infrared data association (IrDA) technology, ultra-wideband (UWB) technology, bluetooth (BT) technology, and the like.

In an embodiment, the device 600 may be implemented by one or more of: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic element, to perform the above methods.

In an embodiment, a non-transitory computer-readable storage medium including an instruction is provided, such as a memory 604 including an instruction. The instruction described above is capable of being executed by the processor 620 of the device 600. For example, the non-transitory computer-readable storage medium may be a ROM, a random access memory (RAM), a CD-ROM, a magnetic tape, a floppy disk, an optical data storage device, etc.

In a first aspect, an HARQ-ACK transmission method is provided by an embodiment of the present disclosure. The method is performed by a network device, or performed by a chip in a network device. The network device may include an access network device, such as a base station, nodeB, and the like.

The method includes sending to a UE information used for indicating an HARQ-ACK sending mode. The HARQ-ACK sending mode is a first sending mode or a second sending mode. The first sending mode corresponds to sending a plurality of HARQ-ACKs on different physical uplink control channels (PUCCHs). The second sending mode corresponds to sending a plurality of HARQ-ACKs on a same PUCCH. The method further includes receiving the HARQ-ACK from the UE.

By using this method, the network device sends to the UE the information used for indicating the HARQ-ACK sending mode, causing the UE to determine the HARQ-ACK sending mode as the first sending mode or the second sending mode according to the indication of the network device. This enables the UE to adopt different HARQ-ACK sending modes for different usage scenarios, reducing the overhead of the PUCCH time domain resources while saving the feedback latency.

In an example, the information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a first priority.

In an example, the information used for indicating the HARQ-ACK sending mode includes first auxiliary information used for determining the HARQ-ACK sending mode. The first auxiliary information is information, in a higher layer signaling, indicating that the first sending mode is used for an HARQ-ACK with a priority higher than a first priority.

In an example, the information used for indicating the HARQ-ACK sending mode further includes second auxiliary information used for determining the HARQ-ACK sending mode. The second auxiliary information is priority information indicated by a priority indication information field in a DCI. The priority information is priorities of HARQ-ACKs corresponding to a plurality of PDSCHs scheduled by the DCI.

In an example, the information used for indicating the HARQ-ACK sending mode includes information used for indicating the first sending mode. The information used for indicating the first sending mode is first indication information in a higher layer signaling. The first indication information is used for indicating that the first sending mode is used for an HARQ-ACK with any priority.

In an example, the information used for indicating the HARQ-ACK sending mode includes information used for indicating the second sending mode. The information used for indicating the second sending mode is a higher layer signaling not including first auxiliary information. The first auxiliary information is used for indicating that the first sending mode is used for an HARQ-ACK with a first priority, or used for indicating that the first sending mode is used for an HARQ-ACK with a priority higher than the first priority.

In an example, the information used for indicating the HARQ-ACK sending mode includes information used for indicating the second sending mode. The information used for indicating the second sending mode is second indication information in a higher layer signaling. The second indication information is used for indicating that the first sending mode is disabled for an HARQ-ACK with a first priority, or used for indicating that the first sending mode is disabled for an HARQ-ACK with a priority higher than the first priority.

In an example, the information used for indicating the HARQ-ACK sending mode includes information used for indicating the second sending mode. The information used for indicating the second sending mode is a higher layer signaling not including first indication information. The first indication information is used for indicating that the first sending mode is used for an HARQ-ACK with any priority.

In an example, the information used for indicating the HARQ-ACK sending mode includes information used for indicating the second sending mode. The information used for indicating the second sending mode is third indication information in a higher layer signaling. The third indication information is used for indicating that the first sending mode is disabled for an HARQ-ACK with any priority.

In a second aspect, an HARQ-ACK transmission method is provided by an embodiment of the present disclosure. The method is performed by a UE, or performed by a chip in a UE. The UE may be a mobile phone.

The method includes receiving from a network device information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH. The method further includes determining the HARQ-ACK sending mode based on the information used for indicating the HARQ-ACK sending mode, and sending the HARQ-ACK to the network device by using the HARQ-ACK sending mode.

By using this method, the UE receives from the network device the information used for indicating the HARQ-ACK sending mode, and determines the HARQ-ACK sending mode as the first sending mode or the second sending mode according to the indication of the network device. This enables the UE to adopt different HARQ-ACK sending modes for different usage scenarios, reducing the overhead of the PUCCH time domain resources while saving the feedback latency.

In an example, the receiving from the network device the information used for indicating the HARQ-ACK sending mode includes receiving from the network device first auxiliary information used for determining the HARQ-ACK sending mode. The first auxiliary information is information, in a higher layer signaling, indicating that the first sending mode is used for an HARQ-ACK with a first priority.

In an example, the receiving from the network device the information used for indicating the HARQ-ACK sending mode includes receiving from the network device first auxiliary information used for determining the HARQ-ACK sending mode. The first auxiliary information is information, in a higher layer signaling, indicating that the first sending mode is used for an HARQ-ACK with a priority higher than a first priority.

In an example, the receiving from the network device the information used for indicating the HARQ-ACK sending mode further includes receiving from the network device second auxiliary information used for determining the HARQ-ACK sending mode. The second auxiliary information used for determining the HARQ-ACK sending mode is priority information indicated by a priority indication information field in a DCI. The priority information is priorities of HARQ-ACKs corresponding to a plurality of PDSCHs scheduled by the DCI.

In an example, the determining the HARQ-ACK sending mode based on the information used for indicating the HARQ-ACK sending mode includes determining the HARQ-ACK sending mode based on the first auxiliary information and the second auxiliary information.

In an example, the determining the HARQ-ACK sending mode based on the first auxiliary information and the second auxiliary information includes one of:
when the first auxiliary information is the information, in the higher layer signaling, indicating that the first sending mode is used for the HARQ-ACK with the first priority, and a priority corresponding to the second auxiliary information is the first priority, determining the HARQ-ACK sending mode is the first sending mode;
when the first auxiliary information is the information, in the higher layer signaling, indicating that the first sending mode is used for the HARQ-ACK with the first priority, and the priority corresponding to the second auxiliary information is not the first priority, determining the HARQ-ACK sending mode is the second sending mode;
when the first auxiliary information is the information, in the higher layer signaling, indicating that the first sending mode is used for the HARQ-ACK with a priority higher than the first priority, and the priority corresponding to the second auxiliary information is higher than the first priority, determining the HARQ-ACK sending mode is the first sending mode; or
when the first auxiliary information is the information, in the higher layer signaling, indicating that the first sending mode is used for the HARQ-ACK with a priority higher than the first priority, and the priority corresponding to the second auxiliary information is lower than or equal to the first priority, determining the HARQ-ACK sending mode is the second sending mode.

In an example, the information used for indicating the HARQ-ACK sending mode is first indication information in a higher layer signaling. The first indication information is used for indicating that the first sending mode is used for an HARQ-ACK with any priority.

The determining the HARQ-ACK sending mode based on the information used for indicating the HARQ-ACK sending mode includes determining that the HARQ-ACK sending mode is the first sending mode.

In an example, the information used for indicating the HARQ-ACK sending mode is a higher layer signaling not including first auxiliary information used for determining the HARQ-ACK sending mode. The first auxiliary information is used for indicating that the first sending mode is used for an HARQ-ACK with a first priority, or used for indicating that the first sending mode is used for an HARQ-ACK with a priority higher than the first priority.

The determining the HARQ-ACK sending mode based on the information used for indicating the HARQ-ACK sending mode includes determining that the HARQ-ACK sending mode is the second sending mode.

In an example, the information used for indicating the HARQ-ACK sending mode is second indication information in a higher layer signaling. The second indication information is used for indicating that the first sending mode is disabled for an HARQ-ACK with a first priority, or used for indicating that the first sending mode is disabled for an HARQ-ACK with a priority higher than the first priority.

The determining the HARQ-ACK sending mode based on the information used for indicating the HARQ-ACK sending mode includes determining that the HARQ-ACK sending mode is the second sending mode.

In an example, the information used for indicating the HARQ-ACK sending mode is a higher layer signaling not including first indication information. The first indication information is used for indicating that the first sending mode is used for an HARQ-ACK with any priority.

The determining the HARQ-ACK sending mode based on the information used for indicating the HARQ-ACK sending mode includes determining that the HARQ-ACK sending mode is the second sending mode.

In an example, the information used for indicating the HARQ-ACK sending mode is third indication information in a higher layer signaling. The third indication information is used for indicating that the first sending mode is disabled for an HARQ-ACK with any priority.

The determining the HARQ-ACK sending mode based on the information used for indicating the HARQ-ACK sending mode includes determining that the HARQ-ACK sending mode is the second sending mode.

In a third aspect, a communication device is provided by an embodiment of the present disclosure. The communication device may be configured to implement the steps performed by the network device in the first aspect described above or in any of possible designs of the first aspect. The network device may implement each of the functions in each of the methods described above by means of a hardware structure, a software module, or a hardware structure plus a software module.

In implementing the communication device shown in the third aspect by means of the software module, the communication device may include a transceiver module and a processing module coupled to each other. The transceiver module may be configured to support the communication device for communication. The processing module may be configured for the communication device to perform a processing operation, such as generating the information/message to be sent, or obtaining the information/message by processing a received signal.

In executing the steps in the first aspect described above, the transceiver module is configured to send to a UE information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH. The transceiver module is further configured to receive the HARQ-ACK from the UE.

In a fourth aspect, a communication device is provided by an embodiment of the present disclosure. The communication device may be configured to execute the steps performed by the UE in the second aspect described above or in any of possible designs of the second aspect. The UE may implement each of the functions in each of the methods described above by means of a hardware structure, a software module, or a hardware structure plus a software module.

In implementing the communication device shown in the fourth aspect by means of the software module, the communication device may include a transceiver module and a processing module coupled to each other. The transceiver module may be configured to support the communication device for communication. The processing module may be configured for the communication device to perform a processing operation, such as generating the information/message to be sent, or obtaining the information/message by processing a received signal.

In executing the steps in the second aspect described above, the transceiver module is configured to receive from a network device information used for indicating an HARQ-ACK sending mode. The HARQ-ACK sending mode is a first sending mode or a second sending mode. The first sending mode corresponds to sending a plurality of HARQ-ACKs on different PUCCHs. The second sending mode corresponds to sending a plurality of HARQ-ACKs on a same PUCCH.

The transceiver module is further configured to send the HARQ-ACK to the network device by using the HARQ-ACK sending mode.

The processing module is configured to determine the HARQ-ACK sending mode based on the information used for indicating the HARQ-ACK sending mode.

In a fifth aspect, a communication system is provided by the present disclosure. The communication system may include the communication device shown in the third aspect and the communication device shown in the fourth aspect. The communication device shown in the third aspect may include a software module and/or a hardware component. The communication device shown in the fourth aspect may include a software module and/or a hardware component.

In a sixth aspect, a communication device is provided by the present disclosure. The communication device includes a processor and a memory. The memory is configured to store a computer program. The processor is configured to execute the computer program to implement the first aspect or any of the possible designs of the first aspect.

In a seventh aspect, a communication device is provided by the present disclosure. The communication device includes a processor and a memory. The memory is configured to store a computer program. The processor is configured to execute the computer program to implement the second aspect or any of the possible designs of the second aspect.

In an eighth aspect, a computer-readable storage medium is provided by the present disclosure. The computer-readable storage medium stores an instruction (or a computer program, a program). The instruction, when scheduled and executed on a computer, causes the computer to perform the first aspect or any of the possible designs of the first aspect.

In a ninth aspect, a computer-readable storage medium is provided by the present disclosure. The computer-readable storage medium stores an instruction (or a computer program, a program). The instruction, when scheduled and executed on a computer, causes the computer to perform the second aspect or any of the possible designs of the second aspect.

The beneficial effects in the above second aspect to the ninth aspect and possible designs thereof may be referred to the description of the beneficial effects of the described method in the first aspect and any of the possible designs thereof.

The network device 102 sends to the UE 101 the information used for indicating the HARQ-ACK sending mode, causing the UE 101 to determine the HARQ-ACK sending mode as the first sending mode or the second sending mode according to the indication of the network device 102. This enables the UE 101 to adopt different HARQ-ACK sending modes for different usage scenarios, reducing the overhead of the PUCCH time domain resources while saving the feedback latency.

After considering the specification and practicing the embodiments disclosed herein, those skilled in the art will easily come up with other implementation solutions of the present disclosure. The present disclosure is intended to cover any variations, uses, or adaptive changes of the present disclosure, which follow the general principles of the present disclosure and include common knowledge or commonly used technical means in the technical field that are not disclosed in the present disclosure. The specification and embodiments are only considered to be illustrative, and the true scope and spirit of the present disclosure are indicated by the following claims.

It should be understood that the present disclosure is not limited to the precise structure which has been described above and illustrated in the accompanying drawings, and that various modifications and alterations may be made without departing from the scope of the present disclosure. The scope of the present disclosure is limited only by the appended claims.

1. A hybrid automatic repeat request acknowledgement (HARQ-ACK) transmission method, comprising:
sending, by a network device to a user equipment (UE), information indicating an HARQ-ACK sending mode, wherein the HARQ-ACK sending mode comprises a first sending mode or a second sending mode, wherein the first sending mode corresponds to sending a plurality of HARQ-ACKs on different physical uplink control channels (PUCCHs), wherein the second sending mode corresponds to sending a plurality of HARQ-ACKs on a same PUCCH; and
receiving, by the network device, an HARQ-ACK from the UE.

2. The method according to claim 1, wherein the information used for indicating the HARQ-ACK sending mode comprises:
first auxiliary information, wherein the first auxiliary information is information, in a higher layer signaling, indicating that the first sending mode is configured for an HARQ-ACK with a first priority.

3. The method according to claim 1, wherein the information indicating the HARQ-ACK sending mode comprises:
first auxiliary information, wherein the first auxiliary information is information, in a higher layer signaling, indicating that the first sending mode is configured for an HARQ-ACK with a priority higher than a first priority.

4. The method according to claim 2, wherein the information indicating the HARQ-ACK sending mode further comprises:
second auxiliary information, wherein the second auxiliary information is priority information indicated by a priority indication information field in a downlink control information (DCI), wherein the priority information indicates priorities of HARQ-ACKs corresponding to a plurality of physical downlink shared channels (PDSCHs) scheduled by the DCI.

5. The method according to claim 1, wherein the information indicating the HARQ-ACK sending mode comprises:
first indication information in a higher layer signaling, wherein the first indication information indicates that the first sending mode is configured for an HARQ-ACK with any priority.

6. The method according to claim 1, wherein the information indicating the HARQ-ACK sending mode comprises:
second indication information in a higher layer signaling without carrying first auxiliary information, wherein the first auxiliary information indicates that the first sending mode is configured for an HARQ-ACK with a first priority or for an HARQ-ACK with a priority higher than the first priority.

7. The method according to claim 1, wherein the information indicating the HARQ-ACK sending mode comprises:
second indication information in a higher layer signaling, wherein the second indication information indicates that the first sending mode is disabled for an HARQ-ACK with a first priority or for an HARQ-ACK with a priority higher than the first priority.

8. (canceled)

9. The method according to claim 1, wherein the information indicating the HARQ-ACK sending mode comprises:
third indication information in a higher layer signaling, wherein the third indication information indicates that the first sending mode is disabled for an HARQ-ACK with any priority.

10. A hybrid automatic repeat request acknowledgement (HARQ-ACK) transmission method, comprising:
receiving, by a user equipment (UE) from a network device, information indicating an HARQ-ACK sending mode, wherein the HARQ-ACK sending mode comprises a first sending mode or a second sending mode, wherein the first sending mode corresponds to sending a plurality of HARQ-ACKs on different physical uplink control channels (PUCCHs), wherein the second sending mode corresponds to sending a plurality of HARQ-ACKs on a same PUCCH;
determining, by the UE, the HARQ-ACK sending mode based on the information indicating the HARQ-ACK sending mode; and
sending, by the UE, the HARQ-ACK to the network device by using the HARQ-ACK sending mode.

11. The method according to claim 10, wherein the method further comprises:
receiving, by the UE, first auxiliary information from the network device, wherein the first auxiliary information is information, in a higher layer signaling, indicating that the first sending mode is configured for an HARQ-ACK with a first priority or an HARQ-ACK with a priority higher than the first priority.

12. (canceled)

13. The method according to claim 11, wherein the method further comprises:
receiving, by the UE, second auxiliary information from the network device, wherein the second auxiliary information is priority information indicated by a priority indication information field in a downlink control information (DCI), wherein the priority information indicates priorities of HARQ-ACKs corresponding to a plurality of physical downlink shared channels (PDSCHs) scheduled by the DCI.

14. The method according to claim 13, wherein the method further comprises:
determining the HARQ-ACK sending mode based on the first auxiliary information and the second auxiliary information.

15. The method according to claim 14, wherein the method further comprises:
determining, in response to that the first auxiliary information indicates that the first sending mode is configured for the HARQ-ACK with the first priority, and the second auxiliary information indicates the first priority, the HARQ-ACK sending mode is the first sending mode;
determining, in response to that the first auxiliary information indicates that the first sending mode is configured for the HARQ-ACK with the first priority, and the second auxiliary information does not indicate the first priority, the HARQ-ACK sending mode is the second sending mode;
determining, in response to that the first auxiliary information indicates that the first sending mode is configured for the HARQ-ACK with the priority higher than the first priority, and the second auxiliary information indicates the priority higher than the first priority, the HARQ-ACK sending mode is the first sending mode; or
determining, in response to that the first auxiliary information indicates that the first sending mode is configured for the HARQ-ACK with the priority higher than the first priority, and the second auxiliary information indicates a priority lower than or equal to the first priority, the HARQ-ACK sending mode is the second sending mode.

16. The method according to claim 10, wherein the method further comprises:
determining, in response to that the information indicating the HARQ-ACK sending mode is first indication information in a higher layer signaling, wherein the first indication information indicates that the first sending mode is configured for an HARQ-ACK with any priority, the HARQ-ACK sending mode is the first sending mode.

17. The method according to claim 10, wherein the method further comprises:
determining, in response to that the information indicating the HARQ-ACK sending mode is a higher layer signaling without carrying first auxiliary information, wherein the first auxiliary information indicates that the first sending mode is configured for an HARQ-ACK with a first priority or an HARQ-ACK with a priority higher than the first priority, the HARQ-ACK sending mode is the second sending mode.

18. (canceled)

19. The method according to claim 10, wherein the method further comprises:
determining, in response to that the information indicating the HARQ-ACK sending mode is a higher layer signaling without carrying first indication information, wherein the first indication information indicates that the first sending mode is configured for an HARQ-ACK with any priority, the HARQ-ACK sending mode is the second sending mode.

20-22. (canceled)

23. An HARQ-ACK transmission apparatus, comprising: a processor and a memory;
wherein the memory is configured to store instructions executable by the processor; and
wherein the processor is configured to perform acts comprising:
sending, to a UE, information indicating an HARQ-ACK sending mode, wherein the HARQ-ACK sending mode comprises a first sending mode or a second sending mode, wherein the first sending mode corresponds to sending a plurality of HARQ-ACKs on different PUCCHs, wherein the second sending mode corresponds to sending a plurality of HARQ-ACKs on a same PUCCH; and
receiving, from the UE, an HARQ-ACK.

24. An HARQ-ACK transmission apparatus, comprising: a processor and a memory;
wherein the memory is configured to store instructions executable by the processor; and
wherein the processor is configured to implement the method according to claim 10.

25. A non-transitory computer-readable storage medium, wherein the non-transitory computer-readable storage medium stores an instruction, wherein the instruction is executed by a processor of a communication device, enabling the communication device to perform the method according to claim 1.

26. A non-transitory computer-readable storage medium, wherein the non-transitory computer-readable storage medium stores an instruction, wherein the instruction is executed by a processor of a communication device, enabling the communication device to perform the method according to claim 10.
